(19) United States
(12) Patent Application Publication
(10) Pub. No.: US 2022/0330280 A1
(43) Pub. Date: Oct. 13, 2022

(54) TRANSLATION OF UE-SPECIFIC FREQUENCY DOMAIN INFORMATION AMONG CELLS IN FIFTH GENERATION WIRELESS NETWORKS

(71) Applicant: Nokia Solutions and Networks Oy, Espoo (FI)

(72) Inventors: Luis Guilherme UZEDA GARCIA, Massy (FR); Andrea MARCANO, Antony (FR); Anna PANTELIDOU, Massy (FR); Fuad ABINADER, Massy (FR)

(21) Appl. No.: 17/608,814

(22) PCT Filed: Jun. 19, 2019
(86) PCT No.: PCT/FI2019/050474

§ 371 Date: Nov. 4, 2021

(51) Int. Cl. H04W 72/12; H04L 5/00

(52) U.S. Cl. CPC H04W 72/1263; H04L 5/0044; H04L 5/0007

(57) ABSTRACT

A network node includes at least one processor and at least one memory including computer program code. The at least one memory and the computer program code are configured to, with the at least one processor, cause the network node to: obtain frequency domain arrangement information for a first cell of a neighbor network node; map a first set of resource blocks allocated to a first user equipment in the first cell to a second set of resource blocks in a second cell of the network node based on the frequency domain arrangement information, the second cell having a frequency domain arrangement different from a frequency domain arrangement for the first cell; allocate a third set of resource blocks to a second user equipment based on the second set of resource blocks; and transmit data to the second user equipment using the third set of resource blocks.

### TECHNICAL FIELD

One or more example embodiments relate to Third Generation Partnership Project (3GPP) New Radio (NR) systems.

### BACKGROUND

Fifth generation (5G) wireless communications networks are the next generation of mobile communications networks. Standards for 5G communications networks are currently being developed by the Third Generation Partnership Project (3GPP). These standards are known as 3GPP New Radio (NR) standards.

### SUMMARY

The scope of protection sought for various example embodiments of the invention is set out by the independent claims. The example embodiments and features, if any, described in this specification that do not fall under the scope of the independent claims are to be interpreted as examples useful for understanding various example embodiments of the invention.

Within a cell of a network node, such as a base station, physical resource blocks (PRBs) may be directly mapped to a common resource block (CRB). However, such direct mapping is not possible across different cells (e.g., of different network nodes) because the different cells may have different Bandwidth Part (BWP) arrangements, cell configurations, user equipment (UE) specific arrangements, etc. This lack of mapping may affect the efficiency of Inter-Cell Interference Coordination (ICIC) mechanisms within a wireless network.

One or more example embodiments provide mechanisms by which network nodes (e.g., base stations, gNBs, eNBs, radio access network (RAN) elements, Central Units (CUs), etc.) exchange information (e.g., over an Xn interface) about their frequency domain arrangements (FDAs), and map resources from a FDA received from a network node to specific resource blocks in its own cell. This mapping may be done by translating the received information relating to the PRBs and CRBs into the physical frequencies used by the network node sending the information and then relating these physical frequencies to the corresponding PRBs utilized by the receiving network node. Each network node may utilize this information to then apply the appropriate ICIC operations to allocate (or reallocate) wireless resources to UEs and transmit data to UEs within the cell using the allocated resources.

One or more example embodiments provide spectrum flexibility that allows multiplexing UEs with different capabilities and/or service requirements on the same carrier and the complexity that this adds to the interference management across neighboring cells.

At least one example embodiment provides a network node including at least one processor and at least one memory including computer program code. The at least one memory and the computer program code are configured to, with the at least one processor, cause the network node to: obtain frequency domain arrangement information for a first cell of a neighbor network node; map a first set of resource blocks allocated to a first user equipment in the first cell to a second set of resource blocks in a second cell of the network node based on the frequency domain arrangement information, the second cell having a frequency domain arrangement different from a frequency domain arrangement for the first cell; allocate a third set of resource blocks to a second user equipment based on the second set of resource blocks; and transmit data to the second user equipment using the third set of resource blocks.

At least one example embodiment provides a network node comprising: means for obtaining frequency domain arrangement information for a first cell of a neighbor network node; means for mapping a first set of resource blocks allocated to a first user equipment in the first cell to a second set of resource blocks in a second cell of the network node based on the frequency domain arrangement information, the second cell having a frequency domain arrangement different from a frequency domain arrangement for the first cell; means for allocating a third set of resource blocks to a second user equipment based on the second set of resource blocks; and means for transmitting data to the second user equipment using the third set of resource blocks.

According to at least some example embodiments, the first set of resource blocks is a first set of physical resource blocks, and the second set of resource blocks is a second set of physical resource blocks. The at least one memory and the computer program code may be further configured to, with the at least one processor, cause the network node to: map the first set of physical resource blocks to a first set of common resource blocks in the first cell, map the first set of common resource blocks to a first frequency range allocated to the first user equipment, map the first frequency range to a second set of common resource blocks in the second cell, and map the second set of common resource blocks in the second cell to the second set of physical resource blocks.

The frequency domain arrangement information may include at least one of carrier frequency location information for the first user equipment, frequency domain anchor information for the first cell, bandwidth part information for the first cell, a cell identifier for the first cell, or a user equipment identifier for the first user equipment.

The at least one memory and the computer program code may be further configured to, with the at least one processor, cause the network node to obtain the frequency domain arrangement information as part of a contextual frequency domain arrangement information element from the neighbor network node.

The at least one memory and the computer program code may be further configured to, with the at least one processor, cause the network node to transmit a request for the frequency domain arrangement information to the neighbor network node, and receive the frequency domain arrangement information from the neighbor network node in response to the request for the frequency domain arrangement information.

The frequency domain arrangement for the first cell may include a first numerology and a first frequency reference point, and the frequency domain arrangement for the second cell may include a second numerology and a second frequency reference point, the second numerology different from the first numerology.

The first numerology may include a first subcarrier spacing and cyclic prefix overhead for the first cell, and the second numerology may include a second subcarrier spacing and cyclic prefix overhead for the second cell.

At least one other example embodiment provides a method for transmitting data in a cell of a network node, the method comprising: obtaining frequency domain arrangement information for a first cell of a neighbor network node; mapping a first set of resource blocks allocated to a first user equipment in the first cell to a second set of resource blocks in a second cell of the network node based on the frequency domain arrangement information, the second cell having a frequency domain arrangement different from a frequency domain arrangement for the first cell; allocating a third set of resource blocks to a second user equipment based on the second set of resource blocks; and transmitting data to the second user equipment using the third set of resource blocks.

According to at least some example embodiments, the first set of resource blocks is a first set of physical resource blocks and the second set of resource blocks is a second set of physical resource blocks. The mapping further may further include mapping the first set of physical resource blocks to a first set of common resource blocks in the first cell, mapping the first set of common resource blocks to a first frequency range allocated to the first user equipment, mapping the first frequency range to a second set of common resource blocks in the second cell, and mapping the second set of common resource blocks in the second cell to the second set of physical resource blocks.

The frequency domain arrangement information may include at least one of carrier frequency location information for the first user equipment, frequency domain anchor information for the first cell, bandwidth part information for the first cell, a cell identifier for the first cell, or a user equipment identifier for the first user equipment.

The obtaining may include obtaining the frequency domain arrangement information as part of a contextual frequency domain arrangement information element from the neighbor network node.

The obtaining may include transmitting a request for the frequency domain arrangement information to the neighbor network node, and receiving the frequency domain arrangement information from the neighbor network node in response to the request for the frequency domain arrangement information.

The frequency domain arrangement for the first cell may include a first numerology and a first frequency reference point, and the frequency domain arrangement for the second cell includes a second numerology and a second frequency reference point, the second numerology different from the first numerology.

The first numerology may include a first subcarrier spacing and cyclic prefix overhead for the first cell, and the second numerology may include a second subcarrier spacing and cyclic prefix overhead for the second cell.

At least one other example embodiment provides a non-transitory computer-readable storage medium storing computer-readable instructions that, when executed at a network node, cause the network node to perform a method for transmitting data in a cell of the network node, the method comprising: obtaining frequency domain arrangement information for a first cell of a neighbor network node; mapping a first set of resource blocks allocated to a first user equipment in the first cell to a second set of resource blocks in a second cell of the network node based on the frequency domain arrangement information, the second cell having a frequency domain arrangement different from a frequency domain arrangement for the first cell; allocating a third set of resource blocks to a second user equipment based on the second set of resource blocks; and transmitting data to the second user equipment using the third set of resource blocks.

At least one other example embodiment provides a network node comprising: at least one processor and at least one memory including computer program code. The at least one memory and the computer program code are configured to, with the at least one processor, cause the network node to: obtain frequency domain arrangement information for a first cell serving a first user equipment, the first cell having a first numerology; map, based on the frequency domain arrangement information, a first set of resource blocks in a first bandwidth part associated with the first cell to a second set of resource blocks in a second bandwidth part associated with a second cell, the first set of resource blocks allocated to the first user equipment, the second cell having a second numerology, which is different from the first numerology; allocate a third set of resource blocks to a second user equipment served by the second cell based on the second set of resource blocks; and transmit data to the second user equipment using the third set of resource blocks.

At least one other example embodiment provides a network node comprising: means for obtaining frequency domain arrangement information for a first cell serving a first user equipment, the first cell having a first numerology; means for mapping, based on the frequency domain arrangement information, a first set of resource blocks in a first bandwidth part associated with the first cell to a second set of resource blocks in a second bandwidth part associated with a second cell, the first set of resource blocks allocated to the first user equipment, the second cell having a second numerology, which is different from the first numerology; means for allocating a third set of resource blocks to a second user equipment served by the second cell based on the second set of resource blocks; and means for transmitting data to the second user equipment using the third set of resource blocks.

According to at least some example embodiments, the first numerology may include a first subcarrier spacing and cyclic prefix overhead, and the second numerology includes a second subcarrier spacing and cyclic prefix overhead.

At least one other example embodiment provides a method for transmitting data in a cell of a network node, the method comprising: obtaining frequency domain arrangement information for a first cell serving a first user equipment, the first cell having a first numerology; mapping, based on the frequency domain arrangement information, a first set of resource blocks in a first bandwidth part associated with the first cell to a second set of resource blocks in a second bandwidth part associated with a second cell, the first set of resource blocks allocated to the first user equipment, the second cell having a second numerology, which is different from the first numerology; allocating a third set of resource blocks to a second user equipment served by the second cell based on the second set of resource blocks; and transmitting data to the second user equipment using the third set of resource blocks.

At least one other example embodiment provides a non-transitory computer-readable storage medium storing computer-readable instructions that, when executed at a network node, cause the network node to perform a method for transmitting data in a cell of a network node, the method comprising: obtaining frequency domain arrangement information for a first cell serving a first user equipment, the first cell having a first numerology; mapping, based on the frequency domain arrangement information, a first set of resource blocks in a first bandwidth part associated with the first cell to a second set of resource blocks in a second bandwidth part associated with a second cell, the first set of resource blocks allocated to the first user equipment, the second cell having a second numerology, which is different from the first numerology; allocating a third set of resource blocks to a second user equipment served by the second cell based on the second set of resource blocks; and transmitting data to the second user equipment using the third set of resource blocks.

The first numerology may include a first subcarrier spacing and cyclic prefix overhead, and the second numerology may include a second subcarrier spacing and cyclic prefix overhead.

### BRIEF DESCRIPTION OF THE DRAWINGS

Example embodiments will become more fully understood from the detailed description given herein below and the accompanying drawings, wherein like elements are represented by like reference numerals, which are given by way of illustration only and thus are not limiting of this disclosure.

FIG. 1 illustrates an example of a Bandwidth Part (BWP) allocation for a carrier with two numerologies.

FIG. 2 illustrates details of the resource grid configuration for the allocation used in FIG. 1 following Third Generation Partnership Project (3GPP) New Radio (NR) Release 15 (Rel-15) settings.

FIG. 3 illustrates example consequences of incorrect interpretation of exchanged Physical Resource Block (PRB) bitmaps across 3GPP NR cells.

FIG. 4 is a flow chart illustrating a method according to example embodiments.

FIG. 5 is a flow chart illustrating another method according to example embodiments.

FIG. 6 illustrates an example translation process for nodes having resource grids with different numerologies.

FIG. 7 is a signal flow diagram illustrating a method according to example embodiments.

FIG. 8 is a signal flow diagram illustrating another method according to example embodiments.

FIG. 9 shows an example implementation of a resource grid to illustrate Inter-Cell Interference Coordination (ICIC) operations according to example embodiments.

FIG. 10 shows another example implementation of a resource grid to illustrate Inter-Cell Interference Coordination (ICIC) operations according to example embodiments.

FIG. 11 shows yet another example implementation of a resource grid to illustrate Inter-Cell Interference Coordination (ICIC) operations according to example embodiments.

FIG. 12 is a block diagram illustrating an example embodiment of a network node.

FIG. 13 illustrates a simplified diagram of a portion of a 3GPP NR access deployment for explaining example embodiments.

### DETAILED DESCRIPTION

Various example embodiments will now be described more fully with reference to the accompanying drawings in which some example embodiments are shown.

Detailed illustrative embodiments are disclosed herein. However, specific structural and functional details disclosed herein are merely representative for purposes of describing example embodiments. The example embodiments may, however, be embodied in many alternate forms and should not be construed as limited to only the embodiments set forth herein.

It should be understood that there is no intent to limit example embodiments to the particular forms disclosed. On the contrary, example embodiments are to cover all modifications, equivalents, and alternatives falling within the scope of this disclosure. Like numbers refer to like elements throughout the description of the figures.

While one or more example embodiments may be described from the perspective of network nodes (e.g., radio access network (RAN) elements, base stations, eNBs, gNBs, Central Units (CUs), ng-eNBs, etc.), user equipment (UE), or the like, it should be understood that one or more example embodiments discussed herein may be performed by the one or more processors (or processing circuitry) at the applicable device. For example, according to one or more example embodiments, at least one memory may include or store computer program code, and the at least one memory and the computer program code may be configured to, with at least one processor, cause a network node to perform the operations discussed herein. As discussed herein, UE and User may be used interchangeably. Moreover, a UE or User may be referred to as being served by the node or cell when the UE or User is within the cell and the node is providing wireless resources for transmission to/from the UE or User.

It will be appreciated that a number of example embodiments may be used in combination.

FIG. 13 illustrates a simplified diagram of a portion of a Third Generation Partnership Project (3GPP) New Radio (NR) access deployment for explaining one or more example embodiments discussed herein.

Referring to FIG. 13, the 3GPP NR radio access deployment includes a gNB (or node) 100 having transmission and reception points (TRPs) 102A and 102B and a gNB (or node) 200 having TRPs 202A and 202B. Each TRP 102A, 102B, 202A, 202B may be, for example, a remote radio head (RRH) or remote radio unit (RRU) including at least, for example, a radio frequency (RF) antenna (or antennas) or antenna panels, and a radio transceiver, for transmitting and receiving data within a geographical area. In this regard, the TRPs 102A, 102B, 202A, 202B provide cellular resources for user equipment (UEs) within a geographical coverage area referred to as a cell. In the example shown in FIG. 13, the TRPs 102A, 102B, 202A, 202B are configured to communicate with one or more UEs (e.g., UE or User 106) via one or more transmit (TX)/receive (RX) beam pairs. The gNBs 100 and 200 communicate with the core network, which is referred to as the New Core in 3GPP NR.

The TRPs 102A, 102B, 202A, 202B may have independent schedulers, or the gNBs 100 and 200 may perform joint scheduling among their respective TRPs.

Although only a single UE 106 is shown in FIG. 13, the gNBs 100 and 200 and their respective TRPs 102A, 102B, 202A, 202B may provide communication services to a relatively large number of UEs within a cell.

More specific details of example embodiments will be described herein with regard to the 3GPP NR access deployment shown in FIG. 13. Although the access deployment shown in FIG. 13 is described with regard to gNBs 100 and 200, the following discussion may refer to these elements more generically as network nodes or nodes. Moreover, it should be understood that example embodiments should not be limited to this example access deployment.

Inter-Cell Interference Coordination (ICIC) provides a set of mechanisms to coordinate and mitigate interference between different cells. The 3GPP Long-Term Evolution (3GPP-LTE) specifications include a rich set of ICIC mechanisms. Despite being a well-known technique originally introduced in Release 8 (Rel-8), new service classes such as Ultra-Reliable Low-Latency Communication (URLLC) traffic in 5th Generation (5G) wireless communications systems may also benefit from the Signal-to-Interference and Noise Ratio (SINR) gains offered by ICIC schemes.

Frequency domain mechanisms are particularly relevant for URLLC traffic and time sensitive networking (TSN) since these mechanisms do not impose temporal restrictions that may penalize time-sensitive traffic.

Due to the very wide carrier bandwidth supported by 3GPP New Radio (NR) (e.g., up to 100 MHz for FR1 and 400 MHz for FR2 in 3GPP NR Release 15 (Rel-15)), the concept of receiver-side bandwidth adaptation has been introduced; namely bandwidth parts (BWPs) in 3GPP NR parlance. 3GPP NR may also be referred to herein as 5G NR or NR.

BWPs are UE-specific bandwidth partitions associated with a carrier and assigned to UEs by gNBs according to the needs of the respective UEs. Each BWP includes a group of contiguous physical resource blocks (PRB) that share a common subcarrier spacing (SCS) and a cyclic prefix overhead (referred to collectively as a numerology). The size in frequency of a BWP may vary from 24 to 275 PRBs, and up to 4 downlink (DL) BWPs and 4 uplink (UL) BWPs may be configured per UE, with only one DL BWP and one UL BWP being active at a given time. The BWPs configured for a UE cannot be larger than the maximum bandwidth (BW) supported by the UE, and the UE is not expected to monitor signals outside the active BWP. This means that the control and data resource allocation from the scheduler at the gNB to a UE must be done within the active BWP (i.e., in-resource physical layer control).

BWP switching is used to activate an inactive BWP and deactivate an active BWP. BWP switching may be done via Downlink Control Information (DCI), Radio Resource Control (RRC) signaling, expiration of an inactivity timer, or Media Access Control (MAC) entity upon initiation of Random Access (RA) procedure. Using BWPs allows multiplexing of narrowband and wideband devices, as well as different numerologies at the same or substantially the same time.

In the case of 3GPP NR Rel-15, five transmission numerologies μ are defined, as shown in Table 1, where Δf is the subcarrier spacing. Numerologies corresponding to μ={0,1,2} are supported in FR1, while those corresponding to μ={2,3} are supported in FR2. In FR2, μ=4 is used for the SS block (synchronization and broadcasting block), but not for data.

TABLE 1

| | | Cyclic | Supported | Supported |
|---|---|---|---|---|
| μ | Δf = 2^{μ} · 15 [kHz] | prefix | for data | for synch |
| 0 | 15 | Normal | Yes | Yes |
| 1 | 30 | Normal | Yes | Yes |
| 2 | 60 | Normal, | Yes | No |
| | | Extended | | |
| 3 | 120 | Normal | Yes | Yes |
| 4 | 240 | Normal | No | Yes |

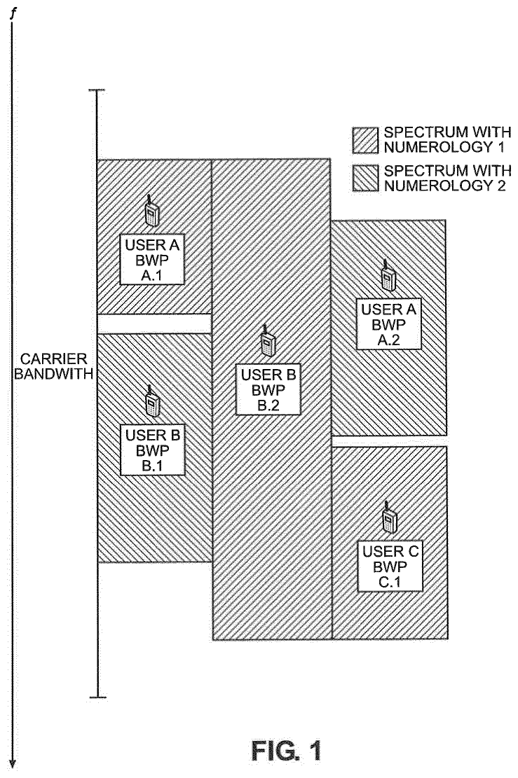

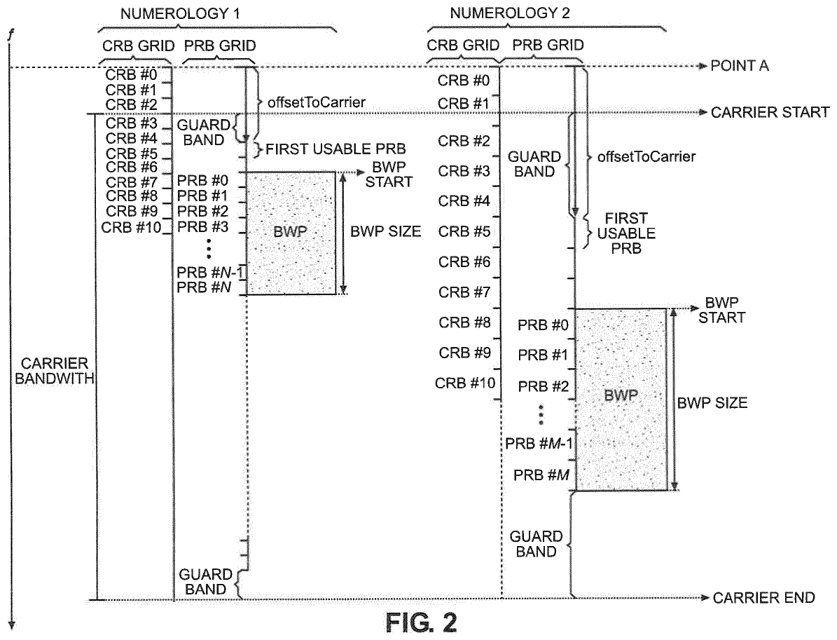

To illustrate the grid configuration of a multiple numerology system, reference is made to FIGS. 1 and 2, which follow the settings of 3GPP NR Rel-15. As discussed herein, the notation ‘BWP X.n’ refers to the nth BWP defined for User X.

FIG. 1 illustrates an example of a BWP allocation for a carrier with two numerologies.

FIG. 2 illustrates details of the resource grid configuration for the first allocation (BWP A.1 and BWP B.1) used in FIG. 1 following 3GPP NR Rel-15 settings.

In Orthogonal Frequency Division Multiplexing (OFDM) systems with mixed numerologies, a common reference point in frequency is needed to have all resource grids in the carrier aligned to avoid constant wavering of interference levels due to the loss of subcarrier orthogonality between different numerologies. The frequency reference point defined in 3GPP NR Rel-15 for having the resource grids aligned in a subcarrier is called Point A. Point A uniquely identifies the band and carrier frequencies used by a given gNB. The location of Point A in frequency is expressed in Absolute Radio Frequency Channel Number (ARFCN), and is broadcast to UEs as part of system information blocks. The Point A may be located outside the spectrum allocation available for the carrier, and defines the start of all the grids corresponding to what is called common resource block (CRB).

A CRB includes a set of 12 consecutive subcarriers. A CRB grid is defined for each numerology (μ), wherein CRBs are numbered from 0 upwards in the frequency domain. For all numerologies, the center of the lowest subcarrier of the CRB 0 coincides with the Point A, thereby aligning all numerologies.

Since some CRBs may be located outside the carrier bandwidth or overlap with the carrier guard bands, the first usable resource block for a given numerology may not coincide with the first CRB. To address this, an offsetToCarrier parameter, which is numerology dependent, indicating the offset between the lowest subcarrier of CRB 0 and the lowest usable subcarrier on the actual carrier bandwidth is defined and broadcasted to UEs. This allows the UEs to define the location and width of the carrier.

Notably, in 3GPP NR Rel-15, the resource allocation for UEs does not occur in terms of CRBs, but rather in terms of physical resource blocks (PRBs) and BWPs. A PRB includes a set of 12 consecutive subcarriers and their numbering is defined only in the context of a BWP; the lowest subcarrier of the first PRB that can be allocated to a UE corresponds to the lowest usable subcarrier on the carrier bandwidth and it defines the start of the PRB grid. PRBs are numbered from 0 upwards in the frequency domain, with PRB 0 indicating the first PRB of the BWP; the start in frequency and size of a BWP is signaled by the gNB, in addition to Point A, in the form of a Resource Indicator Value (RIV), which is defined using the offsetToCarrier and the subcarrier spacing for the BWP.

A direct mapping between the PRBs and the CRBs for a given numerology is defined in 3GPP NR Rel-15 so that a UE can translate its allocation in PRBs inside the BWP into CRBs in the corresponding numerology grid and then into an actual usable frequency (PRB→CRB→frequency domain resources).

As described above, the use of Point A allows for CRB grids with different numerologies to be aligned in the same 3GPP NR cell, and the use of offsetToCarrier allows a direct mapping between PRBs and CRBs for a given numerology. However, this does not guarantee grid alignment across different 3GPP NR cells because, as mentioned above, both parameters (Point A and offsetToCarrier) depend on (i) the cell configuration and (ii) the frequency location of each numerology grid (for CRBs and PRBs) in the cell. Moreover, the numerologies supported and activated by each cell as well as the BWP arrangement at a given time (which depends on the scheduling decisions at each Transmission Time Interval (TTI)) also varies across cells. This loss of a common reference mapping between network nodes (e.g., gNBs), introduced by numerologies multiplexing and BWPs, may hinder the direct application of existing ICIC schemes.

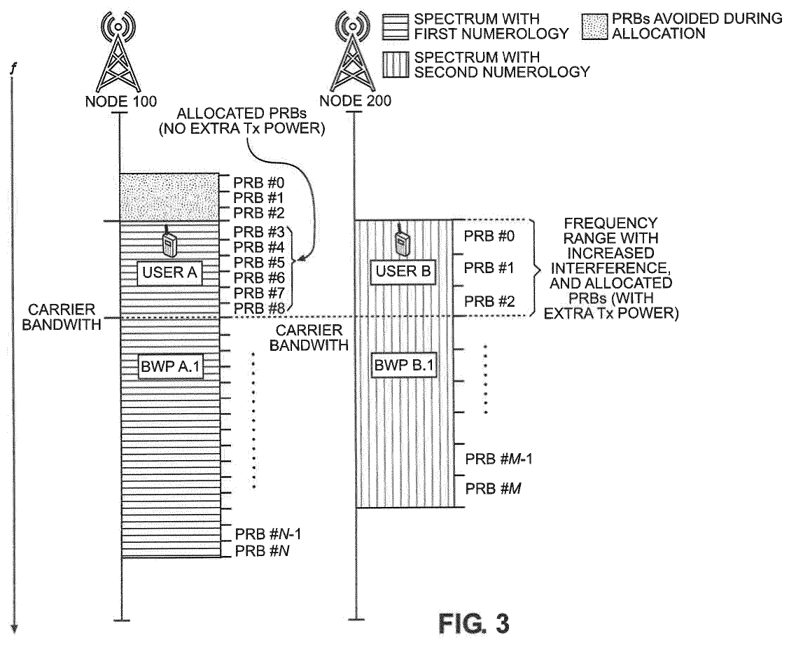

FIG. 3 illustrates example consequences of incorrect interpretation of exchanged PRB bitmaps across 3GPP NR cells.

In FIG. 3, we consider a simple scenario in which node 100 assigns BWP A.1 for User A using a first numerology (e.g., 15 KHz), and node 200 independently assigns BWP B.1 for User B using a second numerology (e.g., 30 KHz). Node 200 then decides to allocate the PRBs [0 . . . 2] in BWP B.1 to User B and transmit on those PRBs with a transmit (TX) power exceeding the Relative Narrowband Transmit Power (RNTP) threshold (e.g., User B may be at the cell-edge). Node 200 then sends an RNTP Information Element (IE) (e.g., RNTP(1,1,1,0,0 . . . )) to node 100 where the values of ‘1’ in the bitmap indicate that the transmission power to User B will exceed the RNTP threshold and values of ‘0’ indicate otherwise.

Because one simple way to reduce the Inter-Cell-Interference (ICI) interference is to coordinate the resource allocation among neighboring cells so that no frequency domain overlap occurs, naïve node 100, which is not aware of the difference in numerology and frequency domain reference points, may blindly follow the indication from node 200 (i.e., avoiding using PRBs [0 . . . 2] at BWP A.1), and allocate the PRBs [3 . . . 8] in BWP A.1 to User A. However, without a proper translation mechanism, the PRBs [3 . . . 8] in BWP A.1 correspond to the very same frequency range allocated to User B (i.e., PRBs [0 . . . 2] in BWP B.1) by node 200. In practice, this leads to both node 100 and node 200 failing to decrease their ICI.

Example embodiments provide a translation mechanism that enables neighboring nodes to exchange information for correctly mapping the resources allocated in one cell with a given numerology and frequency reference point into an actual frequency range in another cell with another given numerology and frequency reference point.

At least one example embodiment provides a mechanism based on limited (Xn) signaling to translate contextual frequency domain arrangements (FDAs) (e.g., numerologies and frequency reference points) among different network nodes. The frequency domain resource data is associated with one or multiple Users served by the network node.

Network nodes may share the necessary parameters to allow nodes to reconstruct the resource grids at other remote nodes, regardless of their current numerologies and frequency domain reference points, thereby allowing a correct mapping of allocated PRBs to specific subsets of frequency ranges. On a more general level, methods according to at least one example embodiment involve at least: (1) dynamic signaling among peer network nodes to enable UE-specific translation of resources (e.g., PRBs within a BWP); (2) dynamic translation and reverse translation to local resource grid(s) and/or BWP specific bitmaps for backward compatibility (e.g., with 3GPP LTE); and/or (3) a framework for information exchange among peer network nodes (e.g., gNBs) pertaining to their frequency domain structure(s) (e.g., as an aggressor cell (source of interference)) or as a victim cell (interfered cell).

The dynamic signaling among peer network nodes may be pre-negotiated and/or on-demand. Moreover, by design, the exchange of information may be carried out by radio access network (RAN) elements controlling the transmissions (e.g., gNBs acting as proxies).

According to one or more example embodiments, the translation and reverse translation to/from local resource grids may be necessary because aggressor and victim cells may have arbitrary frequency domain structures and need to be able to infer which PRBs affect/are affected locally and/or at the neighboring cell. This mutual understanding may be relevant for eCoMP hypothesis and evaluation of benefit metrics.

The framework for information exchange may include sharing contextual information, which is not (necessarily) known a priori, to establish a common ground. In at least one example embodiment, the proposed signaling and translation mechanism may be applied to enable the use of UE-specific BWPs as the basis for coarse-grained frequency domain ICIC schemes. The latter may provide enhanced support for Remote Interference Management (RIM) and/or Ultra-Reliable-and-Low-Latency Communications (URLLC) traffic.

Example embodiments differ from the more trivial solution of exchanging actual frequency ranges in Hz. Exchanging actual frequency ranges avoids the need for a translation, but is not backward compatible and implies the exchange of (at least) a pair of float values (absolute frequency range start and end, respectively), rather than of integer numbers (initial and final PRB indices), which may lead to inaccuracies and/or higher control signaling cost. Another limitation of this kind of solution is the fact that the frequency information exchanged is only valid for a specific UE at a specific time, and does not provide any information regarding the resource grid configuration.

As discussed above, when two (or more) nodes (e.g., gNBs) with cells sharing the same frequency band need to carry out (frequency domain) ICIC procedures, the nodes must have knowledge of the numerologies and frequency domain reference points from each other's resource subsets. According to at least one example embodiment, the nodes should have the following information items when locating a subset of resources in the frequency domain:
a) frequency range/frequency band supported by the UE: represented as a vector of integers. Values integer (1 . . . 1024) are used in 3GPP NR.
b) Subcarrier spacing: represented as a string. Values enumerated {kHz15, kHz30, kHz60, kHz120, kHz240, spare3, spare2, spare1} are used in 3GPP NR;
c) frequency domain anchor point (i.e., Point A): represented as an integer (ARFCN value). Values integer (0 . . . maxNARFCN) are used in 3GPP NR;
d) frequency offset (numerology dependent) from anchor point to where the first usable PRB is located (i.e., offsetToCarrier): represented as an integer in number of PRBs. Values integer (0 . . . 2199) are used in 3GPP NR;
e) Location and bandwidth of the BWP (i.e., start and width of the BWP): represented as an integer (i.e., in the form of a resource indicator value (RIV) as defined in 3GPP NR) that requires later processing to derive the BWP related information. Values integer (0 . . . 37949) are used in 3GPP NR;
f) Allocated PRBs in the BWP: represented as a bitmap or as an integer (in the form of a RIV). If a RIV is used, information item (e) is required for decoding. Values integer (0 . . . 37949) are used in 3GPP NR;
g) CRBs corresponding to allocation PRBs (alternative to information items (e) and (f) above): represented as a bitmap or as an integer; and
h) User ID: represented as an integer. Values integer (0 . . . 65535) are used in 3GPP NR

The information related to resource allocation may be exchanged on a per PRB or per CRB basis using either bitmaps or integers (e.g., resources range with a start resource and a length/end resource). Note that the option of using a bitmap to indicate the resources in terms of CRBs implies the use of relatively large bitmaps, especially for cases with relatively small subcarrier spacing (e.g., 15 KHz) and relatively large carrier bandwidths (e.g., 100 MHz).

The information items related only to the grid information (items (b)-(d) in the list above) and not to the actual resource allocation in the grid need only be exchanged for the first coordination between nodes and then again when such information items are changed/updated.

According to at least one example embodiment, a new Contextual Frequency Domain Arrangement Information Element (CtxFDA IE) is introduced to facilitate exchange of information between nodes. The CtxFDA IE is exchanged between nodes to share contextual information on FDAs. An example structure of a CtxFDA IE is shown below in Table 2.

TABLE 2
Example CtxFDA IE Structure

| | Mandatory/ | |
|---|---|---|
| Field | Optional? | Data Type |
| CtxFDA ID | M | Integer |
| CtxFDA Length | M | Integer |
| Carrier Location | M | Struct |
| Frequency Range | M | Integer |
| Frequency Band | M | Integer |
| Frequency Domain Anchor | M | Struct |
| Numerology ID | M | Integer |
| Point A | M | Integer |
| Frequency Offset | M | Integer |
| Frequency Domain Arrangement | O | Struct |
| BWP Location and Bandwidth | O | Integer |
| BWP Allocated PRBs | O | Bitmap |
| Cell Identification | O | Struct |
| Cell ID | O | Integer |
| User Identification | O | Struct |
| User ID | O | Integer |

By using information contained in the CtxFDA IE, a node may map resources from one FDA at a cell in a neighbor node to specific resource blocks in one of its own cells. This process of mapping resources between FDAs on cells in different nodes is sometimes referred to herein as a translation mechanism. The translation mechanism between resource grids with different numerologies includes mapping the allocated resource (PRB) indices considering a first numerology into actual frequency values and then back into allocated resource (PRB) indices considering a different second numerology. Since the frequency value is not numerology dependent, the frequency value is a common reference for both numerologies.

According to at least one example embodiment, following what is specified for 3GPP NR, the PRB-to-CRB mapping may be performed by knowing the offsetToCarrier (to set the start of the PRB grid) and the first PRB (derived from the RIV) of the BWP in question. The CRB-to-frequency mapping may be performed by knowing the Point A, which sets the start of the CRB grid.

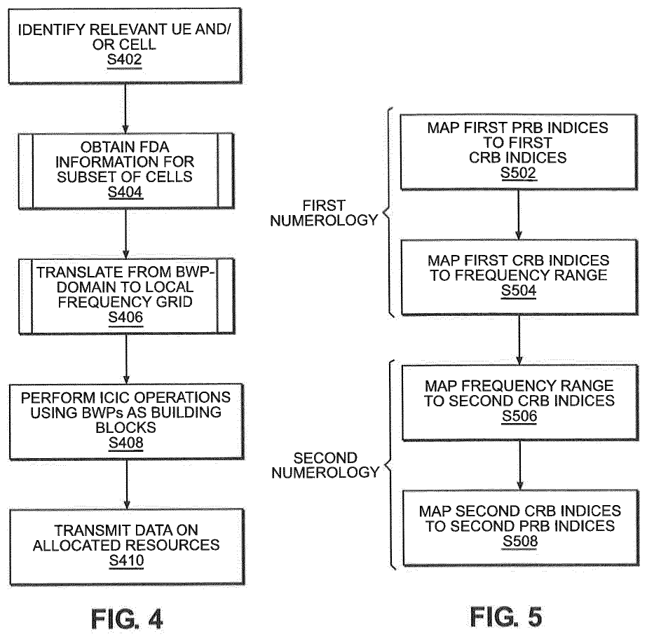

FIG. 4 is a flow chart illustrating a method according to example embodiments.

For example purposes, the example embodiment shown in FIG. 4 will be discussed with regard to node 100 and node 200 shown in FIG. 13.

Referring to FIG. 4, at step S402 node 200 identifies a UE and/or cell (e.g., a cell-edge, URRLC or CLI prone devices, etc.) associated with node 200 for which translation of wireless resources from the BWP-domain to the local frequency grid relevant is deemed necessary.

According to one or more example embodiments, node 200 may identify a UE and/or cell by detecting a victim/aggressor UE and/or cell. In one example, node 200 may detect a victim/aggressor UE and/or cell by having the victim UE search for all possible aggressor UEs and/or cells (e.g., those for which a relatively high Reference Signal Received Power (RSRP) is reported), and then allowing the network identify the aggressor. However, a UE and/or cell may be identified at step S402 in any suitable manner, which may be based on implementation.

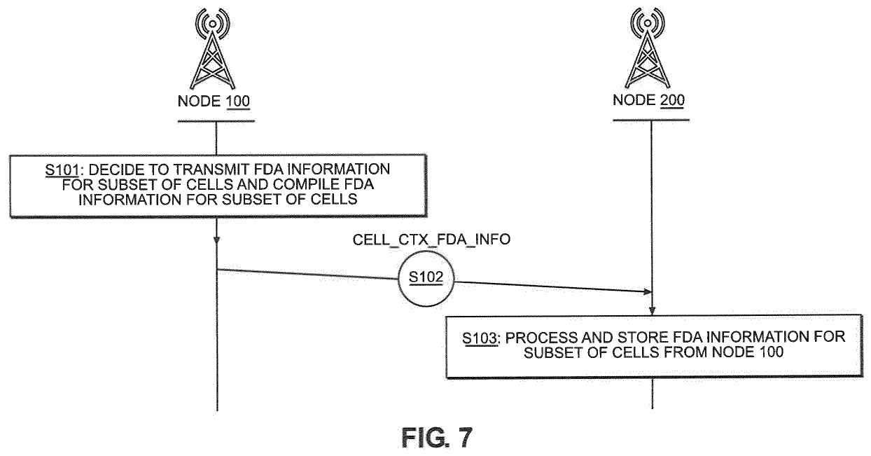

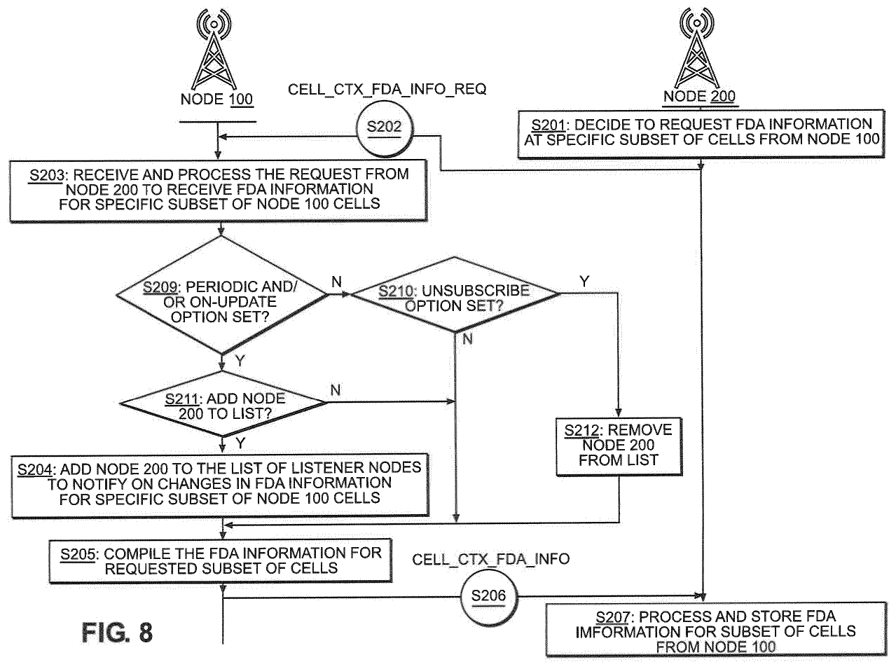

At step S404, node 200 obtains the FDA information for the subset of cells at node 100 based on the relevant UEs and/or cells identified at step S402. Example embodiments of methods for obtaining FDA information (also referred to herein as FDA contextual information) for the subset of cells at node 100 will be discussed below with regard to FIGS. 7 and 8.

FIGS. 7 and 8 are signal flow diagrams illustrating methods for exchanging FDA information (e.g., Contextual Frequency Domain Arrangement Information Elements (CtxFDA IEs)) between nodes 100 and 200 in FIG. 13. In the example embodiment shown in FIG. 7, node 100 advertises the FDA information at specific cells to victim/aggressor nodes, such as node 200. In the example embodiment shown in FIG. 8, node 200 requests the FDA information at specific cells from node 100.

Referring to FIG. 7, at step S101, node 100 decides to transmit FDA information for a subset of its own cells to at least node 200 based on one or more of a plurality of policies. In one example, node 100 may be statically configured to periodically broadcast/unicast, to other nodes, FDA information for a subset of its own cells meeting certain criteria (e.g., having associated UEs, which reported being victims of ICI from aggressor terminals/nodes in those addressed nodes). In another example, node 100 may dynamically decide to start advertising, to other nodes, FDA information for a subset of its cells in response to, for example, the identification that these cells have been victims of ICI to provide information for potential aggressor nodes to engage in ICIC procedures. In yet another example, the event of an update of FDAs for a specific subset of its cells (e.g., due to the creation/activation of a novel BWP with different numerology) may trigger node 100 to notify all previously-subscribed nodes (including, e.g., node 200), which require updated FDA information for that subset of cells of node 100. In still another example, the expiration of a periodic timer previously set when, for example, node 200 explicitly requests to be periodically updated, may trigger the node 100 to provide the FDA information. In a final example, node 200 may explicitly request updated FDA information for a subset of cells in node 100. Example embodiments should not be limited to these example policies.

Still referring to FIG. 7, at step S102, node 100 transmits a cell FDA information message CELL_CTX_FDA_INFO including FDA information (e.g., CtxFDA IEs) for the subset of its cells to node 200. Once the decision to transmit the FDA information to other nodes is made, node 100 compiles the contextual information on FDAs for the subset of its own cells in one of the formats discussed above, and broadcasts/unicasts the information to the node 200 in the cell FDA information message CELL_CTX_FDA_INFO.

In one example, the cell FDA information message CELL_CTX_FDA_INFO message is unicasted to a subset of potential ICI victims and aggressor nodes, including node 200 in this example, via the Xn interface. In another example, the cell FDA information message CELL_CTX_FDA_INFO is disseminated to a subset of potential ICI victims and aggressor nodes via an Operations Administration and Maintenance (OAM) message. In yet another example, the cell FDA information message CELL_CTX_FDA_INFO may be broadcasted via the Uu control channel over the air interface to all neighbor nodes, including node 200 in this example.

At step S103, node 200 processes the received FDA information message CELL_CTX_FDA_INFO and stores the FDA information for the subset of the cells at node 100.

In more detail, when node 200 receives the cell FDA information message CELL_CTX_FDA_INFO from node 100, node 200 processes the message and stores (e.g., locally in memory/hard disk, or even remotely in a database at core network or cloud) the available FDA information for the advertised subset of cells from node 100.

In one example, node 200 processes the cell FDA information message CELL_CTX_FDA_INFO by filtering out contextual mapping information (e.g., information from the CtxFDA IEs pertaining to cells of node 100, which are operating in frequency ranges and/or frequency bands where node 200 does not contain an operating cell). In another example, node 200 processes the cell FDA information message CELL_CTX_FDA_INFO by filtering out frequency mapping information related to cells in which neither ICI aggressor interference was detected nor ICI victim UEs were identified. In another example, node 200 stores all reported frequency mapping information opportunities to preemptively be prepared to acquire frequency mapping information for any cell of node 100 in the future.

As discussed in more detail later, the stored FDA information may be used by node 200 to map resources from a FDA at a cell of node 100 to specific resource blocks in one of its own cells.

Referring now to the example embodiment shown in FIG. 8, at step S201 node 200 decides to request FDA information for a specific subset of cells from node 100. Node 200 may have acquired knowledge of the existence of a subset of cells of node 100 that coexist with a subset of its own cells through a multitude of ways. For example, node 200 may have knowledge of the coexisting subset of cells through static O&M configuration because of, for example, network planning, drive tests or other empirical evidence. In another example, the knowledge may be history-based from previous reception of messages from node 100 (e.g., cell FDA information messages) containing FDA information for a subset of node 100 cells. In yet another example, node 200 may acquire the knowledge on-demand based on previous ICI reports from victim UEs indicating the existence of aggressor, node 100 cells.

Given that node 200 has acquired knowledge of the existence of a subset of node 100 cells that coexist with a subset of its own cells, node 200 may decide to request FDA information or updated FDA information (e.g., updated CtxFDA IEs) at these specific cells following a multitude of policies. In one example, the update requests may be reactive in response to the need for implementing ICIC procedures to a specific subset of victim/aggressor terminals at specific subset of cells in the remote node. In another example, the update requests may be proactive or preemptive requests to assemble all possible FDA information at cells of remote nodes, in preparation to more quickly implement ICIC procedures when needed.

Node 200 may also specify to node 100 the frequency with which it wants to receive such FDA information for the subset of node 100 cells. In one example, node 200 may inform node 100 that node 200 needs an instantaneous update (One-Time) on the current FDA information available for that specific subset of node 100 cells, without compromise whatsoever from node 100 to send further updates of any type. In another example, node 200 informs node 100 that it should periodically compile and transmit refreshed (updated) FDA information for the specific subset of node 100 cells. Node 200 informs node 100 that node 100 should compile and transmit refreshed FDA information in the specific subset of node 100 cells whenever there is a change (On-Update) in these due to, for example, creation of a BWP with a different numerology, or any other type of change that may cause previously shared FDA information from node 100 to be considered outdated.

Node 200 may inform node 100 that it no longer needs to receive updated FDA information for the specific set of node 100 cells (Unsubscribe).

Still referring to step S201, according to at least some example embodiments, node 200 may inform any combination of the possible frequencies of updates in the request, for example, One-Time (e.g., instantaneous), Periodic, and/or On-Update (e.g., in response to changes) of FDA information from node 100.

Once the decision to request FDA information for a specific subset of node 100 cells is made, at step S202 node 200 prepares and transmits a cell FDA information request message CELL_FDA_INFO_REQ to node 100. The cell FDA information request message CELL_FDA_INFO_REQ includes a list of the cells at node 100 for which node 200 requests updated FDA information. In one example embodiment, node 200 may choose to represent the resources (cells) at node 100 for which it requests updated FDA information in different forms, including (but not limited to):
a) A list of specific cell IDs for which node 200 wants to receive FDA information from node 100;
b) A list of frequency bands identifiers (IDs), along with their respective frequency range IDs, for which node 200 wants to receive FDA information from node 100, in case node 100 actually has cells with FDAs operating in those frequency bands; or
c) A list of specific UE identification signals (e.g., extracted from reference signals like SRS) for which node 200 wants to receive FDA information from node 100.

The cell FDA information request message CELL_FDA_INFO_REQ may also include one or more frequencies for which to receive the updated FDA information for a specific subset of node 100 cells, including, but not limited to: One-Time, Periodic, On-Update, or the like, as discussed above.

The cell FDA information request message CELL_FDA_INFO_REQ may be, for example, unicasted to node 100 via the Xn interface or alternatively broadcasted via the Uu air interface.

At step S203, node 100 receives the cell FDA information request message CELL_FDA_INFO_REQ from node 200. Also at step S203, node 100 processes the cell FDA information request message CELL_FDA_INFO_REQ to determine further actions to take in response. In one example, node 100 compares the requested list of cells and/or frequency bands for which to receive updated FDA information on to its own cells and/or frequency bands in which it has ongoing established FDAs, and further processes (e.g., only) those cells and/or frequency bands identified in the request that match cells and/or frequency bands with ongoing established FDAs at node 100. Node 100 may store, for future use, the cells and/or frequency bands in the request from the node 200 that do not match cells and/or frequency bands with ongoing established FDAs at node 100, in the case node 100 establishes an FDA in any of those cells and/or frequency bands.

Node 100 may choose to not proceed with any response to the requested FDA information in the requested cells and/or frequency bands (either matching or non-matching), if node 100 considers engaging in ICIC procedures is not in the best interest of its served UEs, or does not trust the information from node 200.

At step S209, if node 100 determines that the cell FDA information request message CELL_FDA_INFO_REQ includes an option to return Periodic and/or On-Update updates of FDA information for those cells and/or frequency bands, then at step S211 node 100 determines whether to add node 200 to the list of listener nodes to notify about changes in FDA information for the specific subset of node 100 cells. In one example, node 100 may decide to add node 200 to the list of listener nodes to notify on changes in FDA information for the specific subset of node 100 cells due to, for example, realizing that engaging in ICIC procedures with node 200 is in the best interests of node 100 at the current time. In another example, node 100 may not add node 200 to the list if node 100 does not support Periodic and/or On-Update updates of FDA information for the specific subset of cells, or does not have enough updates available for the specific subset of cells to warrant an update. In yet another example, node 100 may decide not to add node 200 to the list of listener nodes if, for example, node 100 decides not to engage in any ICIC procedures for that subset of cells, or even recognize node 200 as a valid remote node to which engaging in ICIC procedures might be in the best interests of node 100 at the current time. Determining whether engaging in ICIC procedures is in the best interests of node 100 at the current time may include determining whether engaging in ICIC is beneficial to node 100 at the current time. Determining whether engaging in ICIC procedures is beneficial to node 100 may be performed in any suitable manner and may be dependent upon implementation policies.

If node 100 determines that node 200 should be added to the list of listener nodes, then at step S204 node 100 adds node 200 to the list of listener nodes to notify of changes in FDA information for the specific subset of node 100 cells.

At step S205, node 100 compiles the contextual information for FDAs for the subset of node 100 cells in the same or substantially the same as discussed above with regard to FIG. 7.

At step S206, node 100 transmits a cell FDA information message CELL_CTX_FDA_INFO including FDA information for the subset of node 100 cells to node 200 in the same or substantially the same manner as discussed above with regard to step S102 in FIG. 7.

At step S207, node 200 processes the received cell FDA information message CELL_CTX_FDA_INFO and stores the FDA information for the subset of the node 100 cells in the same or substantially the same manner as discussed above with regard to step S103 in FIG. 7.

Returning to step S211, if node 100 decides not to add node 200 to the list of listener nodes, then the process proceeds to step S205 and continues as discussed above.

Returning to step S209, if the Periodic and/or On-Update options are not set in the cell FDA information request message CELL_FDA_INFO_REQ from the node 200, then at step S210 the node 100 determines whether the Unsubscribe option is set in the cell FDA information request message CELL_FDA_INFO_REQ. As mentioned above, the Unsubscribe option requests that the node 200 be unsubscribed (not receive) updates of FDA information for the specific subset of node 100 cells. Node 200 may still, however, request and receive the cell FDA information message CELL_CTX_FDA_INFO including FDA information for the subset of node 100 cells by sending to the cell FDA information request message CELL_FDA_INFO_REQ to node 100.

If the Unsubscribe option is not set, then the process proceeds to step S205 and continues as discussed above.

Returning to step S210, if the Unsubscribe option is set, then at step S212 node 100 removes node 200 from the list of listener nodes stored at node 100. The process then proceeds to step S205 and continues as discussed above.

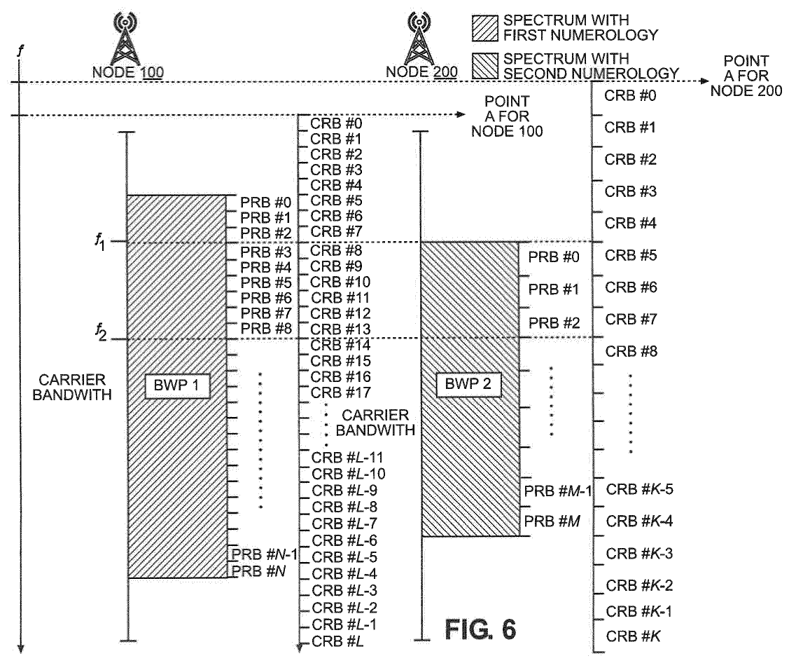

Returning now to FIG. 4, once node 200 has obtained FDA information for the subset of node 100 cells (e.g., via one or more cell FDA information messages CELL_CTX_FDA_INFO including one or more CtxFDA IEs), node 200 may translate wireless resources (e.g., allocated to a UE) from the BWP-domain in a node 100 cell among the subset of node 100 cells to the local frequency grid at node 200 based on the FDA information from the node 100. An example embodiment of step S406 will be discussed in more detail below with regard to FIGS. 5 and 6.

FIG. 5 is a flow chart illustrating an example embodiment of step S406 in more detail. For example purposes, the example embodiment shown in FIG. 5 will be discussed with regard to nodes 100, 200 and UE 106 shown in FIG. 13.

Referring to FIG. 5, at step S502, node 200 maps the first set of PRB indices S₁^{PRB} allocated to UE 106 in a first BWP (of the node 100 cell) to a first set of CRB indices S₁^{CRB} in the first BWP using the first numerology. According to at least one example embodiment, node 200 performs the mapping by establishing a frequency relation between the PRBs and CRBs. Since both resource grids use the same numerology, the PRBs and CRBs are aligned in frequency. As an example, the approach used in 3GPP NR, as defined in TS 38.211 (sec. 4.4.4.4), where the relation between the PRB n_{PRB}^{μ}^{₁}, with {n_{PRB}^{μ}^{₁}∈S₁^{PRB}}, in BWP BWP_i and the CRB n_{CRB}^{μ}^{₁}, with {n_{CRB}^{μ}^{₁}∈S₁^{CRB}}, for numerology μ₁ is given by Equation (1) shown below, may be used.

n_{CRB}^{μ}^{₁}=n_{PRB}^{μ}^{₁}+N_{BWP_i}^{start,μ}^{₁} (1)

In Equation (1), N_{BWP_i}^{start,μ}^{₁} is the CRB index where BWP BWP_i starts relative to CRB 0.

At step S504, node 200 maps the indices in first set of CRB indices S₁^{CRB} in the first BWP to a frequency range in the first BWP for the wireless resources allocated to the UE 106 using the first numerology.

In more detail, at step S504 node 200 may calculate the frequency range corresponding to each of the CRB indices in the first set of CRB indices S₁^{CRB} based on the start frequency of CRB 0 (e.g., point A in 3GPP NR), the number of subcarriers per CRB and the subcarrier spacing.

For numerology μ₁, as shown below in Equation (2), the CRB index n_{CRB}^{μ}^{₁} is related to the number of subcarriers per RB N_{sc}^{RB} (e.g., 12 subcarriers in 3GPP LTE and 3GPP NR) and the index k in frequency of the first subcarrier of the CRB in question (k=0 corresponds to the first subcarrier of CRB 0, which is centered on Point A).

n_{CRB}^{μ}^{₁}=└k/N_{sc}^{RB}┘ (2)

To obtain the initial frequency f_{CRB}^{init} of the CRB indices in the first set of CRB indices S₁^{CRB}, node 200 may multiply the k index of the lowest subcarrier of the first CRB (i.e., initial k index k_{μ}_{₁}^{init}) by the subcarrier spacing SCS_{μ}_{₁} of the numerology μ₁, and add the frequency value of Point A_{μ}_{₁} for numerology μ₁ as shown below in Equation (3).

f_{CRB}^{init}=k_{μ}_{₁}^{init}*SCS_{μ}_{₁}+Point A_{μ}_{₁} (3)

In this case, the initial frequency f_{CRB}^{init} of the CRB indices in the first set of CRB indices S₁^{CRB} refers to the initial frequency of the CRB range (the start frequency of first CRB with the first numerology).

Node 200 may then calculate the end frequency f_{CRB}^{end} of the CRB indices in the first set of CRB indices S₁^{CRB} using the k index of the lowest subcarrier of the last CRB (i.e., k_{μ}_{₁}^{end}), the frequency value of Point A_{μ}_{₁}, the number of subcarriers per RB NR_{sc}^{RB} and the subcarrier spacing SCS_{μ}_{₁} as shown below in Equation (4).

f_{CRB}^{end}=SCS_{μ}_{₁}*(k_{μ}_{₁}^{end}+N_{sc}^{RB}−1)+Point A_{μ}_{₁} (4)

In this case, the end frequency f_{CRB}^{end} of the CRB indices in the first set of CRB indices S₁^{CRB} refers to the end frequency of the CRB range (the end frequency of the last CRB with the first numerology).

The frequency range between the initial frequency f_{CRB}^{init} and the end frequency f_{CRB}^{end} is the frequency range of the CRB range.

At step S506, node 200 maps the frequency range (f_{CRB}^{init},f_{CRB}^{end}) determined at step S504 to a second set of CRB indices S₂^{CRB} in a second BWP (of node 200) using a second numerology μ₂ by performing the inverse of step S504 to obtain the CRB indices by adjusting the subcarrier spacing and Point A according to the second numerology μ₂ that is, SCS_{μ}_{₂} and Point A_{μ}_{₂}.

In more detail, for example, node 200 may calculate the initial CRB index k_{μ}_{₂}^{init} in the second set of CRB indices S₂^{CRB} by using the initial frequency f_{CRB}^{init} obtained from Equation (3), the subcarrier spacing of the second numerology and the frequency value of the Point A for numerology μ₂ (i.e., Point A_{μ}_{₂}) as shown below in Equation (5).

$${k}_{{μ}_{2}}^{init} = ⌊ \frac{{f}_{CRB}^{init} - Point {A}_{{μ}_{2}}}{{SCS}_{{μ}_{2}}} ⌋ \qquad ( 5 )$$

The end CRB index k_{μ}_{₂}^{end} in the second set of CRB indices S₂^{CRB} may be given by Equation (6) shown below, using the f_{CRB}^{end} value obtained from Equation (4) .

$${k}_{{μ}_{2}}^{end} = ⌊ \frac{{f}_{CRB}^{end} - Point {A}_{{μ}_{2}}}{{SCS}_{{μ}_{2}}} ⌋ \qquad ( 6 )$$

For each of the k value, i.e., k_{μ}_{₂}^{init}≤k≤k_{μ}_{₂}^{end}, the equivalent CRB index n_{CRB}^{μ}^{₂} may be determined according to Equation (7) shown below.

$${n}_{CRB}^{{μ}_{2}} = ⌊ \frac{k}{{N}_{sc}^{RB}} ⌋ \qquad ( 7 )$$

At step S508, node 200 maps the second set of CRB indices S₂^{CRB} to a second set of PRBs S₂^{PRB} in the second BWP using the second numerology μ₂ by applying the inverse procedure of step S502 to map each CRB index n_{CRB}^{μ}^{₂} to a PRB index n_{PRB}^{μ}^{₂} with the second numerology μ₂.

In more detail, for example, at step S508 node 200 may map each of the CRB indices n_{CRB}^{μ}^{₂}, with {n_{CRB}^{μ}^{₂}∈S₂^{CRB}}, obtained at step S506 to a PRB index n_{PRB}^{μ}^{₂}, with {n_{PRB}^{μ}^{₂}∈S₂^{PRB}}, according to the translation mechanism shown below in Equation (8).

n_{CRB}^{μ}^{₂}=n_{PRB}^{μ}^{₂}+N_{BWP_j}^{start,μ}^{₂} (8)

In Equation (8), N_{BWP_j}^{start,μ}^{₂} is the CRB index where BWP BWP_j (second BWP) starts relative to CRB 0 for numerology μ₂.

FIG. 6 illustrates an example translation process for nodes 100 and 200, each with a resource grid with a different numerology. By following the translation method shown in FIG. 5, for example, node 200 may map a first set of PRBs PRB[3 . . . 8] in BWP 1 to a set of first CRB indices CRB[8 . . . 13] (step S502), and then map the set of first CRB indices CRB[8 . . . 13] into a frequency range f[f₁. . . f₂] (step S504) using the first numerology μ₁.

Node 200 may map the frequency range f[f₁. . . f₂] to a set of second CRB indices CRB[5 . . . 7] (step S506), and then map the set of second CRB indices to a set of second PRB indices PRB[0 . . . 2] in BWP 2 (step S508) using the second numerology μ₂.

Returning again to FIG. 4, once having translated the wireless resources at step S406, the node 200 performs ICIC operations based on the translated wireless resources and allocates (or re-allocates) wireless resources for transmission to UEs as necessary at step S408.

Node 200 then transmits data to UEs using the allocated wireless resources in any well-known manner at step S410.

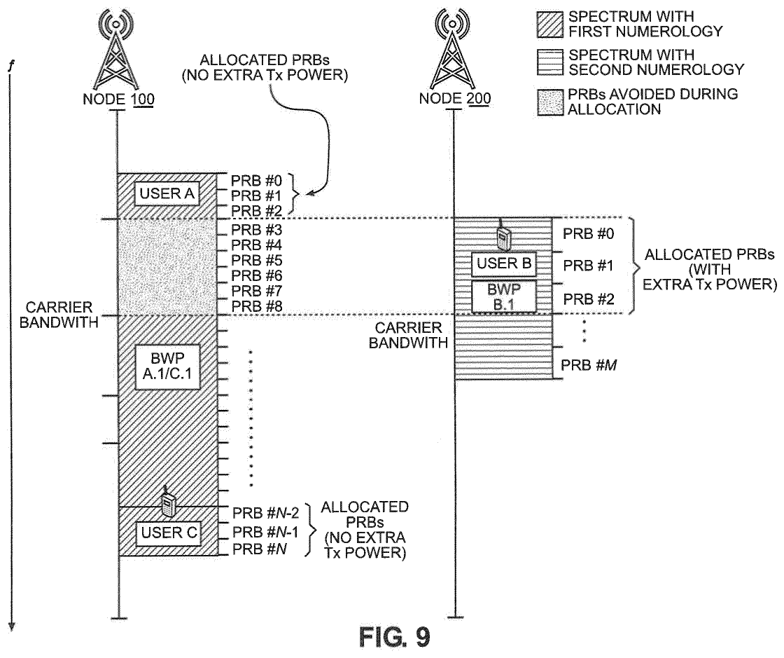

Example ICIC operations that may be performed at step S408, in accordance with example embodiments, will be described below with regard to FIGS. 9-11.

As mentioned earlier, a full grid configuration need only be exchanged if at least one of the grid configuration related FDA information items changes. To illustrate this, we assume a simple implementation such as that shown in FIG. 9 with nodes 100 and 200 from FIG. 13 being 3GPP NR gNBs exchanging FDA information for the first time.

In this example, node 200 informs node 100 that node 200 is using relatively high transmit power for User B and exchanges the information needed for node 100 to recreate the corresponding resource grid and avoid scheduling PRBs where relatively high interference is found (e.g., PRB[0 . . . 2] in BWP B.1).

Following the recommendations from node 200, node 100 allocates User A and User C accordingly (e.g., by avoiding PRB[3 . . . 8] in BWP A.1/C.1).

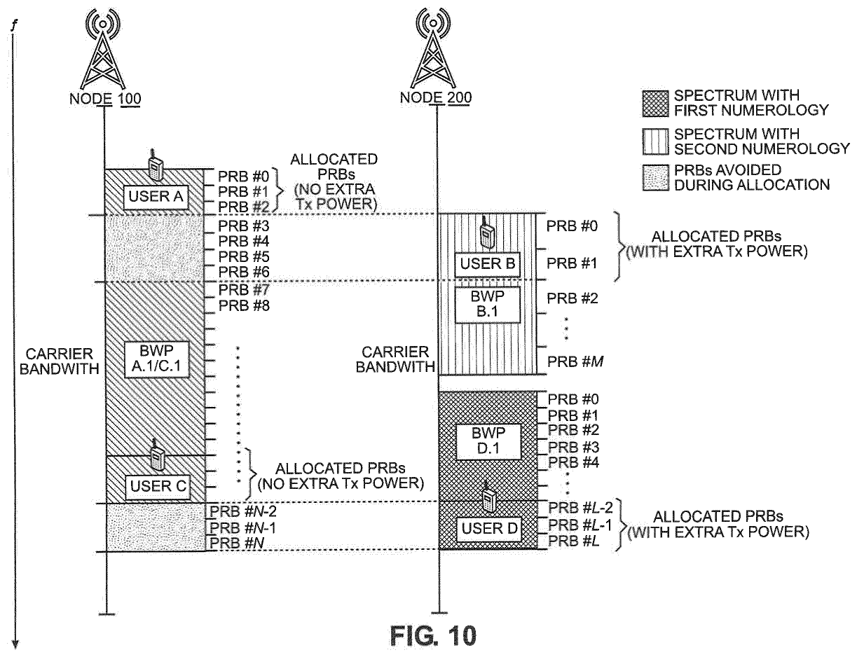

As shown in FIG. 10, node 200 changes the allocation for User B in the same BWP B.1 as before, and schedules User D in its BWP D.1. In this case, node 200 is using extra transmit power for both User B and User D. As a result, node 200 decides to inform node 100 of the new allocation decisions that might affect the performance of node 100. For User B, node 200 need only inform node 100 that the allocation has changed from PRB[0 . . . 2] in BWP B.1 to PRB[0 . . . 1] in BWP B.1 since the FDA information to map those PRBs into actual frequencies was previously exchanged. Thus, information such as Point A and offsetToCarrier need not be resent.

For User D, however, node 200 informs node 100 of all information items to allow node 100 to recreate the resource grid for node 200 for the first numerology, since this is the first time such information is required. Additionally, User D's resource allocation (PRB[L−2. . . L]) is also exchanged. In response to the received information, node 100 decides to maintain User A's resource allocation since this allocation is not affected by the changes in the scheduling decision by node 200, but decides to move User C to avoid allocation on the previously allocated PRB[N−2 . . . N] since relatively large interference from User D may be experienced there.

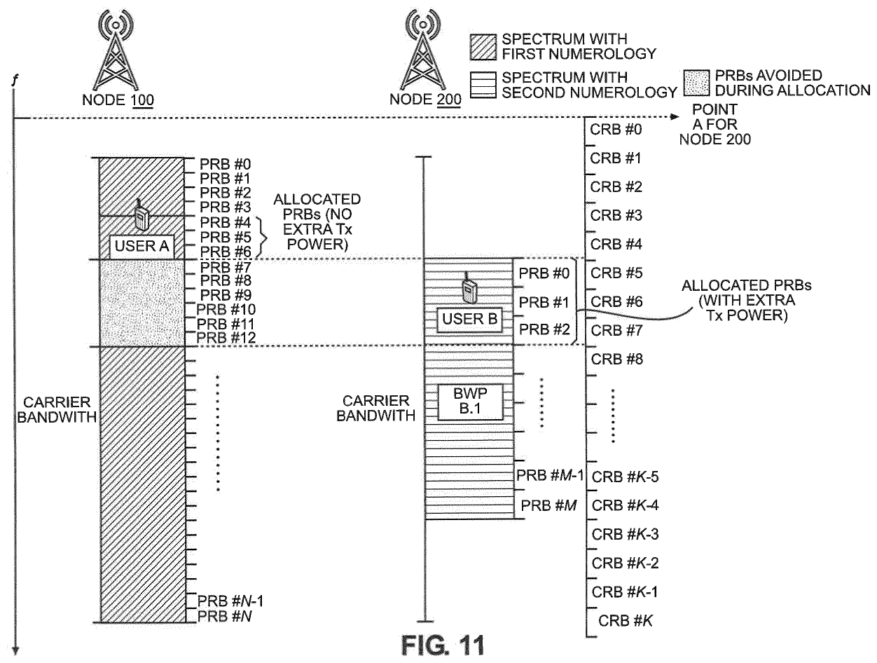

Example embodiments may also be applicable to a case in which one of the nodes involved only supports one numerology and is not aware of BWPs and CRBs (e.g., one of the nodes is a 3GPP LTE node), whereas the other, neighboring node does support multiple numerologies and BWPs (e.g., the other node is a 3GPP NR node). In this case, the neighboring 3GPP NR node may perform all the resource mapping between the nodes. As a result, the resource grid information is used locally by the 3GPP NR node that supports multiple numerologies. This example scenario is illustrated in FIG. 11. In the example shown in FIG. 11, node 100 is a 3GPP LTE node and node 200 is a 3GPP NR node.

Referring to FIG. 11, node 200 increases the transmit power for User B in BWP B.1 (PRB[0 . . . 2]/CRB[5 . . . 7]) and informs node 100 of this decision in terms of only the resource grid known and handled by node 100 (i.e., PRB resource grid for the first numerology).

For node 200, this results in a relatively straightforward mapping of its PRBs with relatively high transmit power into the corresponding PRBs for node 100 (PRB[7 . . . 12]), since only the first numerology can be used by node 100 and parameters such as Point A, offsetToCarrier and CRBs are not configured for node 100.

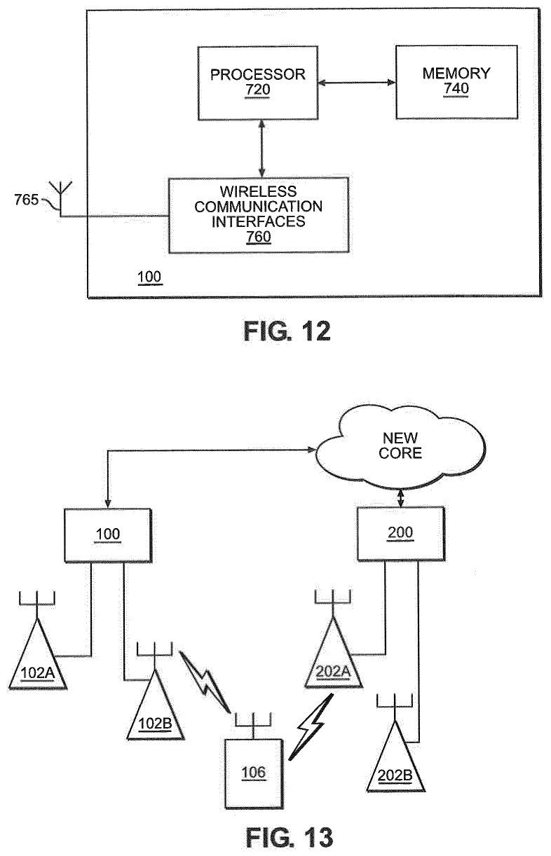

FIG. 12 illustrates an example embodiment of a node, such as a gNB.

As shown, the gNB includes: a memory 740; a processor 720 connected to the memory 740; various interfaces 760 connected to the processor 720; and one or more antennas or antenna panels 765 connected to the various interfaces 760. The various interfaces 760 and the antenna 765 may constitute a transceiver for transmitting/receiving data to/from a UE via a plurality of wireless beams or to/from one or more TRPs. As will be appreciated, depending on the implementation of the gNB, the gNB may include many more components than those shown in FIG. 12. However, it is not necessary that all of these generally conventional components be shown in order to disclose the illustrative example embodiment.

The memory 740 may be a computer readable storage medium that generally includes a random access memory (RAM), read only memory (ROM), and/or a permanent mass storage device, such as a disk drive. The memory 740 also stores an operating system and any other routines/modules/applications for providing the functionalities of the node (e.g., functionalities of a node, methods according to example embodiments, etc.) to be executed by the processor 720. These software components may also be loaded from a separate computer readable storage medium into the memory 740 using a drive mechanism (not shown). Such separate computer readable storage medium may include a disc, tape, DVD/CD-ROM drive, memory card, or other like computer readable storage medium (not shown). In some example embodiments, software components may be loaded into the memory 740 via one of the various interfaces 760, rather than via a computer readable storage medium.

The processor 720 may be configured to carry out instructions of a computer program by performing the arithmetical, logical, and input/output operations of the system. Instructions may be provided to the processor 720 by the memory 740.

The various interfaces 760 may include components that interface the processor 720 with the antenna 765, or other input/output components. As will be understood, the various interfaces 760 and programs stored in the memory 740 to set forth the special purpose functionalities of the node will vary depending on the implementation of the node.

The interfaces 760 may also include one or more user input devices (e.g., a keyboard, a keypad, a mouse, or the like) and user output devices (e.g., a display, a speaker, or the like).

Although not specifically discussed herein, the configuration shown in FIG. 12 may be utilized to implement, inter alia, TRPs, gNBs, other radio access and backhaul network elements, Central Units (CUs), eNBs, ng-eNBs, or the like. In this regard, for example, the memory 740 may store an operating system and any other routines/modules/applications for providing the functionalities of the TRPs, gNBs, etc. (e.g., functionalities of these elements, methods according to the example embodiments, etc.) to be executed by the processor 720.

Although the terms first, second, etc. may be used herein to describe various elements, these elements should not be limited by these terms. These terms are only used to distinguish one element from another. For example, a first element could be termed a second element, and similarly, a second element could be termed a first element, without departing from the scope of this disclosure. As used herein, the term “and/or,” includes any and all combinations of one or more of the associated listed items.

When an element is referred to as being “connected,” or “coupled,” to another element, it can be directly connected or coupled to the other element or intervening elements may be present. By contrast, when an element is referred to as being “directly connected,” or “directly coupled,” to another element, there are no intervening elements present. Other words used to describe the relationship between elements should be interpreted in a like fashion (e.g., “between,” versus “directly between,” “adjacent,” versus “directly adjacent,” etc.).

The terminology used herein is for the purpose of describing particular embodiments only and is not intended to be limiting. As used herein, the singular forms “a,” “an,” and “the,” are intended to include the plural forms as well, unless the context clearly indicates otherwise. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Specific details are provided in the following description to provide a thorough understanding of example embodiments. However, it will be understood by one of ordinary skill in the art that example embodiments may be practiced without these specific details. For example, systems may be shown in block diagrams so as not to obscure the example embodiments in unnecessary detail. In other instances, well-known processes, structures and techniques may be shown without unnecessary detail in order to avoid obscuring example embodiments.

As discussed herein, illustrative embodiments will be described with reference to acts and symbolic representations of operations (e.g., in the form of flow charts, flow diagrams, data flow diagrams, structure diagrams, block diagrams, etc.) that may be implemented as program modules or functional processes include routines, programs, objects, components, data structures, etc., that perform particular tasks or implement particular abstract data types and may be implemented using existing hardware at, for example, existing user equipment, base stations, eNBs, RRHs, gNBs, femto base stations, network controllers, computers, Central Units (CUs), ng-eNBs, other radio access or backhaul network elements, or the like. Such existing hardware may be processing or control circuitry such as, but not limited to, one or more processors, one or more Central Processing Units (CPUs), one or more controllers, one or more arithmetic logic units (ALUs), one or more digital signal processors (DSPs), one or more microcomputers, one or more field programmable gate arrays (FPGAs), one or more System-on-Chips (SoCs), one or more programmable logic units (PLUs), one or more microprocessors, one or more Application Specific Integrated Circuits (ASICs), or any other device or devices capable of responding to and executing instructions in a defined manner.

Although a flow chart may describe the operations as a sequential process, many of the operations may be performed in parallel, concurrently or simultaneously. In addition, the order of the operations may be re-arranged. A process may be terminated when its operations are completed, but may also have additional steps not included in the figure. A process may correspond to a method, function, procedure, subroutine, subprogram, etc. When a process corresponds to a function, its termination may correspond to a return of the function to the calling function or the main function.

As disclosed herein, the term “storage medium,” “computer readable storage medium” or “non-transitory computer readable storage medium” may represent one or more devices for storing data, including read only memory (ROM), random access memory (RAM), magnetic RAM, core memory, magnetic disk storage mediums, optical storage mediums, flash memory devices and/or other tangible machine-readable mediums for storing information. The term “computer-readable medium” may include, but is not limited to, portable or fixed storage devices, optical storage devices, and various other mediums capable of storing, containing or carrying instruction(s) and/or data.

Furthermore, example embodiments may be implemented by hardware, software, firmware, middleware, microcode, hardware description languages, or any combination thereof. When implemented in software, firmware, middleware or microcode, the program code or code segments to perform the necessary tasks may be stored in a machine or computer readable medium such as a computer readable storage medium. When implemented in software, a processor or processors will perform the necessary tasks. For example, as mentioned above, according to one or more example embodiments, at least one memory may include or store computer program code, and the at least one memory and the computer program code may be configured to, with at least one processor, cause a network element or network device to perform the necessary tasks. Additionally, the processor, memory and example algorithms, encoded as computer program code, serve as means for providing or causing performance of operations discussed herein.

A code segment of computer program code may represent a procedure, function, subprogram, program, routine, subroutine, module, software package, class, or any combination of instructions, data structures or program statements. A code segment may be coupled to another code segment or a hardware circuit by passing and/or receiving information, data, arguments, parameters or memory contents. Information, arguments, parameters, data, etc. may be passed, forwarded, or transmitted via any suitable technique including memory sharing, message passing, token passing, network transmission, etc.

The terms “including” and/or “having,” as used herein, are defined as comprising (i.e., open language). The term “coupled,” as used herein, is defined as connected, although not necessarily directly, and not necessarily mechanically. Terminology derived from the word “indicating” (e.g., “indicates” and “indication”) is intended to encompass all the various techniques available for communicating or referencing the object/information being indicated. Some, but not all, examples of techniques available for communicating or referencing the object/information being indicated include the conveyance of the object/information being indicated, the conveyance of an identifier of the object/information being indicated, the conveyance of information used to generate the object/information being indicated, the conveyance of some part or portion of the object/information being indicated, the conveyance of some derivation of the object/information being indicated, and the conveyance of some symbol representing the object/information being indicated.

According to example embodiments, user equipment, base stations, eNBs, RRHs, gNBs, femto base stations, network controllers, computers, Central Units (CUs), ng-eNBs, other radio access or backhaul network elements, or the like, may be (or include) hardware, firmware, hardware executing software or any combination thereof. Such hardware may include processing or control circuitry such as, but not limited to, one or more processors, one or more CPUs, one or more controllers, one or more ALUs, one or more DSPs, one or more microcomputers, one or more FPGAs, one or more SoCs, one or more PLUs, one or more microprocessors, one or more ASICs, or any other device or devices capable of responding to and executing instructions in a defined manner.

Benefits, other advantages, and solutions to problems have been described above with regard to specific embodiments of the invention. However, the benefits, advantages, solutions to problems, and any element(s) that may cause or result in such benefits, advantages, or solutions, or cause such benefits, advantages, or solutions to become more pronounced are not to be construed as a critical, required, or essential feature or element of any or all the claims.

1.-20. (canceled)

21. A network node comprising:
at least one processor; and
at least one memory including computer program code, the at least one memory and the computer program code configured to, with the at least one processor, cause the network node to:
obtain frequency domain arrangement information for a first cell of a neighbor network node;
map a first set of resource blocks allocated to a first user equipment in the first cell to a second set of resource blocks in a second cell of the network node based on the frequency domain arrangement information, the second cell having a frequency domain arrangement different from a frequency domain arrangement for the first cell;
allocate a third set of resource blocks to a second user equipment based on the second set of resource blocks; and
transmit data to the second user equipment using the third set of resource blocks.

22. The network node of claim 21, wherein
the first set of resource blocks is a first set of physical resource blocks;
the second set of resource blocks is a second set of physical resource blocks; and
the at least one memory and the computer program code are further configured to, with the at least one processor, cause the network node to:
map the first set of physical resource blocks to a first set of common resource blocks in the first cell;
map the first set of common resource blocks to a first frequency range allocated to the first user equipment;
map the first frequency range to a second set of common resource blocks in the second cell; and
map the second set of common resource blocks in the second cell to the second set of physical resource blocks.

23. The network node according to claim 21, wherein the frequency domain arrangement information includes at least one of:
carrier frequency location information for the first user equipment,
frequency domain anchor information for the first cell,
bandwidth part information for the first cell,
a cell identifier for the first cell, or
a user equipment identifier for the first user equipment.

24. The network node according to claim 21, wherein the at least one memory and the computer program code are further configured to, with the at least one processor, cause the network node to obtain the frequency domain arrangement information as part of a contextual frequency domain arrangement information element from the neighbor network node.

25. The network node according to claim 21, wherein the at least one memory and the computer program code are further configured to, with the at least one processor, cause the network node to:
transmit a request for the frequency domain arrangement information to the neighbor network node; and
receive the frequency domain arrangement information from the neighbor network node in response to the request for the frequency domain arrangement information.

26. The network node according to claim 21, wherein
the frequency domain arrangement for the first cell includes a first numerology and a first frequency reference point; and
the frequency domain arrangement for the second cell includes a second numerology and a second frequency reference point, the second numerology different from the first numerology.

27. The network node according to claim 26, wherein
the first numerology includes a first subcarrier spacing and cyclic prefix overhead for the first cell; and
the second numerology includes a second subcarrier spacing and cyclic prefix overhead for the second cell.

28. A method for transmitting data in a cell of a network node, the method comprising:
obtaining frequency domain arrangement information for a first cell of a neighbor network node;
mapping a first set of resource blocks allocated to a first user equipment in the first cell to a second set of resource blocks in a second cell of the network node based on the frequency domain arrangement information, the second cell having a frequency domain arrangement different from a frequency domain arrangement for the first cell;
allocating a third set of resource blocks to a second user equipment based on the second set of resource blocks; and
transmitting data to the second user equipment using the third set of resource blocks.

29. The method of claim 28, wherein
the first set of resource blocks is a first set of physical resource blocks;
the second set of resource blocks is a second set of physical resource blocks; and
the mapping further includes
mapping the first set of physical resource blocks to a first set of common resource blocks in the first cell;
mapping the first set of common resource blocks to a first frequency range allocated to the first user equipment;
mapping the first frequency range to a second set of common resource blocks in the second cell; and
mapping the second set of common resource blocks in the second cell to the second set of physical resource blocks.

30. The method according to claim 28, wherein the frequency domain arrangement information includes at least one of:
carrier frequency location information for the first user equipment,
frequency domain anchor information for the first cell,
bandwidth part information for the first cell,
a cell identifier for the first cell, or
a user equipment identifier for the first user equipment.

31. The method according to claim 28, wherein the obtaining comprises:
obtaining the frequency domain arrangement information as part of a contextual frequency domain arrangement information element from the neighbor network node.

32. The method according to claim 28, wherein the obtaining comprises:
transmitting a request for the frequency domain arrangement information to the neighbor network node; and
receiving the frequency domain arrangement information from the neighbor network node in response to the request for the frequency domain arrangement information.

33. The method according to claim 28, wherein
the frequency domain arrangement for the first cell includes a first numerology and a first frequency reference point; and
the frequency domain arrangement for the second cell includes a second numerology and a second frequency reference point, the second numerology different from the first numerology.

34. The method according to claim 33, wherein
the first numerology includes a first subcarrier spacing and cyclic prefix overhead for the first cell, and
the second numerology includes a second subcarrier spacing and cyclic prefix overhead for the second cell.

35. A network node comprising:
at least one processor; and
at least one memory including computer program code, the at least one memory and the computer program code configured to, with the at least one processor, cause the network node to:
obtain frequency domain arrangement information for a first cell serving a first user equipment, the first cell having a first numerology;
map, based on the frequency domain arrangement information, a first set of resource blocks in a first bandwidth part associated with the first cell to a second set of resource blocks in a second bandwidth part associated with a second cell, the first set of resource blocks allocated to the first user equipment, the second cell having a second numerology, which is different from the first numerology;
allocate a third set of resource blocks to a second user equipment served by the second cell based on the second set of resource blocks; and
transmit data to the second user equipment using the third set of resource blocks.

36. The network node of claim 35, wherein the first numerology includes a first subcarrier spacing and cyclic prefix overhead, and the second numerology includes a second subcarrier spacing and cyclic prefix overhead.
